(19) United States
(12) Patent Application Publication
(10) Pub. No.: US 2019/0392112 A1
(43) Pub. Date: Dec. 26, 2019

(54) Systems and Methods Calculating Particle-Level Chemical Engineering and Spectrometry by Orthogonal Segments of Subatomic Particles Calculating Specialized Anisotropic Force Based upon Rotatable Axis for Such Subatomic Particles

(71) Applicant: Eric Arno Vigen, Calabasas, CA (US)

(72) Inventor: Eric Arno Vigen, Calabasas, CA (US)

(21) Appl. No.: 16/013,574

(22) Filed: Jun. 20, 2018

(51) Int. Cl. G06F 19/00

(52) U.S. Cl. CPC G06F 19/701

(57) ABSTRACT

Prior art methods of calculating chemical bonds, and chemical reactions utilize empirical or statistical methods. My prior filing teachings describe a magnetic-like field, called ‘nucleomagnetics’, for each particle, which aids calculations of the position, velocity, bonding strength, and other attributes gets calculated by previous filings in this series. The prior filings allow three-dimensional calculations for electrons relative to a nucleus, its particles, and its nucleomagnetics axis, as a set, in that frame of reference. My prior filings focused on methods related to that nucleomagnetics field from the nucleus particles. From that basis, the electron positions, shells, subshells, and bonding angles calculate. This filing adds the systems and methods a) to calculate forces from or to other particles with their nucleomagnetics axis, beyond the nucleus upon which filings previously focused, b) methods to calculate derivative force, including surface-force-differential tensors at the particle level using that nucleomagnetics invention; c) multiple-atom and multi-molecules interactions such as chemical reactions, and d) determine a time-sequence based upon those other particles operating freely, including their rotation, and d) include calculation of external forces, including traditional magnetics and gravity, and e) create engineering systems, including software for all steps and processes. Further, this adds f) other particles with no electrostatic charge, such as photons and neutrinos.

### BACKGROUND OF THE INVENTION

The present invention relates to the engineering process, using computers, for chemical reactions. Many engineering, technical teachings underlying these methods initially are described under my prior patent filings (U.S. Ser. No. 15/521,248, U.S. Ser. No. 15/256,865, U.S. Ser. No. 15/490,870), and in my many other filings on specific applications of this chain of teachings and inventions inclusive, by the herein same inventor, sometimes with others. All my prior filings are incorporated into this application herein by reference (37 CFR 1.78) and its teachings are generally referenced here as the Arno Vigen Scrunched Cube (“AVSC”) Atomic Model.

The prior filings and teachings apply those filings to this classification of chemical engineering utilizing a specialized anisotropic force at the subatomic particle level, hereafter “nucleomagnetics” which is different than traditional magnetics, arising as the particle location and its axis orientation with specific methods of calculations for forces from subatomic particle interaction(s) identified in my chain of filings. Each subatomic particle has a nucleomagnetics axis, and its two poles. Those teachings show the shape of nucleomagnetics is repulsive between the nucleus and electrons at both poles, and nucleomagnetics operates with strength varying based upon the inclination angle only from those poles. That inclination strength increases in a relationship from 1× at the poles to 2× at the equator. In the present invention teachings, the nucleomagnetics force does not change based upon changes in the longitude angle relative to the nucleomagnetics axis. However, critical to the present invention, the particle itself can rotate which then rotates its nucleomagnetics field with its 1× to 2× changing strength at various inclination orientations which then impacts other particles, hence the methods and systems herein. Finally, that combination can further create torque to change the orientation and rotation speed of the subatomic particle itself.

Electrons are in shells because electrostatic force and my nucleomagnetics force work in equilibrium; that keeps negative electrons from falling (by electrostatic alone) into the positive protons of the nucleus. That calculation requires the equilibrium calculation of 1/distance-squared electrostatic force versus 1/distance-cube nucleomagnetics with that inclination angle factor integrated. The forces have different strength-over-distance calculations, and different geometric profiles. My inventions provide a method that applies that calculation to determine compact settling positions in 3D space for electron particles relative to the nucleomagnetics axis of the nucleus (protons and neutrons) and the number and settling position(s) of the other surrounding electrons. Further, that determines the chemical properties specific to each element and isotope in the Periodic Table of Elements. All those teachings are incorporated herein to the present invention.

In the present invention, additional methods, beyond my prior filing inventions, create methods and a system to create engineering calculations, time-studies, and even animations on a 2D screen of inter-particle and multi-particle interactions in tiny 3D space. Particularly, instead of focusing on the nucleus nucleomagnetics field, the present invention system includes methods to use in calculations the nucleomagnetics fields of other particles, including, without limitation, electrons and photons, to generate a chemical engineering calculation and reaction time-study in 3D space. The application of nucleomagnetics fields of electrons and photon will generate spectrum engineering results. Particularly, it resolves the dual-slit phenomenon and Stern-Gerlach experiment deterministically in 3D.

More practically, and the focus herein, the present invention calculates inter-molecule and intra-molecule forces for chemical electronegativity in 3D without the statistical overload on computer processing using prior art statistical (quantum) methods. The prior art focuses on electrostatic force only, which is isotropic, not my discovery of an anisotropic subatomic force based upon a nucleomagnetics axis. This makes the force calculation of every particle deterministic. Removing statistical process makes the engineering modeling use less computer processing power which is one reason for the present method. The other method is that the present invention provides better results for a broad spectrum where prior art methods diverge from observations (because they miss the anisotropic teaching herein). The prior methods often require supercomputers, and the present invention eliminates that statistical, exponential expansion of computer processing work to get resulting calculations.

One of the present invention methods is the use of subatomic particle segments for field differential tensors, particularly with the addition of the anisotropic ‘nucleomagnetics’ force to the isotropic electrostatic charge force. Even in my prior invention, as presented, the method to calculate a force between nucleus and electron would be only along that direct line, net attractive or repulsive, both only in that particle-particle 1D line. Further, in prior art of others, that calculation of electrostatic force applies using only isotropic forces also only along that direct line. The present invention method of force calculation by segmentation or by mathematical difference (differential) calculation, to get a net force in 3D with an amplitude at a tangent to that net-force field lines of strength (you know one example as the lines in the macro-magnetic shape on paper with iron fillings over a magnet—however, understand that macro-magnetics is not nucleomagnetics in that the FIG. 2 formula is different than a macro-magnet's toroid formula) direct-line direction, and its field with its magnetic-like shape. In that way, the present invention, even beyond my prior filings, invents a method, using segmentation processes in computers, to calculate particle movement in a different direction other than the line between the particles.

This is critical as the present invention allows computerized methods of calculation for a subatomic particle to move in knowable ways that are not straight lines between particles at subatomic distances. One element of the force calculated by the present invention moves at the tangent to the field, which most often is not the direct line between the particles. Only the coincidence of a particle exactly on the nucleomagnetics axis would yield, for the present invention segment-of-a-particle method, a force that has the same line of direction for the tensor force as the line of direction of both electrostatic and pure nucleomagnetics forces. However, even that result also matches observed results better than statistical prior art. A sample of that calculation is found at FIG. 6.

In addition, this system uses the subatomic particle segmentation calculation method to determine subatomic particle rotation, beyond the 3D movement, which is critical because that further changes the fields strength (by definition anisotropic forces are not consistent spherically). That changes to relative forces of structure, at the basic three of position, speed, and acceleration (net-force), but also for any subatomic particle's axis orientation, rotation, and net-force changes such (angular torque) based upon not just the particles set, but also based upon other molecules, external magnetics, and gravity which also change the orientation of particles, and thereby their forces, and their 3D directions of movement. The a) subatomic particle 3D movement and b) subatomic particle (with its nucleomagnetics axis and anisotropic 3D force) rotation elements driven by the present invention generates chemical reaction paths which identify reaction potentials, such as electronegativity, attributes and their rate of occurrence. Further, that generates time-studies and animation at the subatomic particle-specific level which are part of the present invention.

Knowing the 3D subatomic particle position for a specific chemical or specific chemical reactions that triggers or blocks chemical reactions are critical to pharmaceuticals, the most commercially important of chemical reactions. Further use of the present invention will improve identification of both ends of chemical testing. New pharmaceuticals get identified not by experiment, but by the present invention whether when and how exterior particles will interaction. Bad chemical reactions are better identified. Good chemical reactions are better identified. These nuances are not available to current chemical engineering systems (other than clinical trials).

### SPECIFICATIONS

This invention relates, generally, to the engineering process, using computers, for chemical reactions; that is computational chemical engineering computer programs. Many engineering, technical teachings underlying the methods of the present invention initially are described under my prior application (U.S. Ser. No. 15/521,248, U.S. Ser. No. 15/256,865, U.S. Ser. No. 15/490,870), and my many other filings on specific applications of this chain of inventions inclusive, by the same inventor herein alone or with others. Those all are incorporated into this application herein by reference (37 CFR 1.78) and generally are referenced as the Arno Vigen Scrunched Cuhe (“AVSC”) Atomic Model.

The present invention uses a computer system which consists of an input method, a processing method, a database table storage method, and output methods as a computer system as depicted in FIG. 24. In certain embodiments, that output is a 2D screen for an animation output. The present invention adds to that a specialized table which includes the data of the 3D orientation of a subatomic particle, and present invention methods of a) calculation of an anisotropic force, nucleomagnetics described below, in particle-particle interactions to b) calculate, store, and utilize that data for multiple chemical engineering uses. The present invention combines those methods (3D movement, subatomic particle with axis of anisotropic force rotation, time-studies, rotational anisotropic forces creating deterministic, electromagnetic spectrum, and such) to make its system in one embodiment, and adds computerized animation, conversion of three-dimensional data (3D) into two-dimensional screen presentation in another embodiment. Computers are well-known prior art, but the methods to calculate, store in database tables, and utilize to create subatomic chemical engineering reports, and even animations, for each subatomic particle, and multi-particle combinations at this deep level of understanding for engineering is not found in prior art. Specifically, the subatomic particle nucleomagnetics axis, orientation, rotation, and such as described herein, are not part of existing standard computer system or current use of computers for chemical reactions.

A few base teachings flow from the public domain are used in the present invention system. Of course, computers. Yet principally for the focus of the present invention, the specification of inter-particle forces includes electrostatic force, as defined by Coulomb. FIG. 1 shows that formula. That formula counts the number of charged particles as designated by ‘Q’ where Q1 is the charge in one side of the transaction, and Q2 is the charge from the other. Electrons always have only one charge, but a nucleus often has more than one charge particle, hence the method of calculation must use multiplication. As these interact with each other, the formula uses Q1 times Q2. That product exerts force based a constant ‘k’ depending on the units of measure; that ‘k’ is universal in the common knowledge. That force gets reduced by the distance-squared (×1/distance-squared) for the force acting on each particle set (Q1 or Q2). This is public domain prior all and gets used in the present invention combined with the present invention methods.

The present invention applies teachings that, for electrostatic calculations, the charge particles can be negative or positive which creates a final calculation is that is physics-positive (repulsive) or physics-negative (attractive) in the line between the interacting particles or particle-sets. That basic math rules of the multiplication of positives and/or negatives leads to the rule that opposites attract (− * + = − OR + * − = −), and like-kind interactions repel (+ * + = + OR − * − = +). A knowledgeable person can apply these rules to determine the electrostatic charge force (Coulomb) for physics and chemistry engineering, and its direction along the line between the two particles or particle-sets.

Importantly for the present invention, this force act in the direct line of the two particles. There is no three-dimensional (3D) aspect to this calculation method. All calculations are one dimensional (1D) where the force, and thereby acceleration of the particles relative to each other, can only increase or decrease, and the force cannot get applied in 3D space (other than the specific direction line between two objects).

My prior filings include the method to calculate a subatomic particle magnetic-like force, called ‘nucleomagnetics’, for each subatomic particle. Yet, those filings focused on calculation methods related to the nucleomagnetics from the nucleus primarily, and the present invention include multiple particles in 3D expanding upon those filings. FIG. 2 shows that formula for the nucleomagnetics force between particles. That formula counts the number of nucleomagnetics particles as designated by ‘M(#)’ where M(#1) is the nucleomagnetics in one side of the transaction, and M(#1) is the nucleomagnetics from the other. As these interact with each other, the formula uses M1 times M2. A constant ‘M’ [or root(M) if only one particle] depending on the units of measure that is universal in the teachings of my prior filing. That force gets reduced by the distance-cubed (×1/distance-cubed) for the force acting on each particle-set (M1 or M2). 1/distance-squared of Coulomb is a different reduction ratio than 1/distance-cubed of AVSC nucleomagnetics. FIG. 2 presents the Vigen (AVSC) nucleomagnetics formula at commercial operating temperatures (˜300 Kelvin).

A minor note that the function of theta [f(θ)] given in FIG. 2, and elsewhere, is an aggregation of elementary forces and movement. Preliminary results have an alternative of that factor calculation method which applies for certain environments, such as near zero Kelvin, of [1+sin(θ)]. The present invention is designed to implement either version which a knowledgeable person can determine appropriate for the situation.

Unlike electrostatic charge, this nucleomagnetics force is repulsive between a nucleus and an electron. Further, it is not expressed (calculated as zero) for interactions electron and electron. Nucleomagnetics gets expressed between nucleons (protons and neutrons) as attractive (nuclear strong interaction). A knowledgeable person can apply such rules to determine the above nucleomagnetics force (AVSC) for physics and chemistry engineering.

Together, these two forces create the reasoning for electrons to remain in the shell (and not fall into the opposite charge protons in the nucleus if using electrostatic force alone as in prior art). The electrostatic force component attracts, and the nucleomagnetics force repels. At some position, these balance in equilibrium in 3D space. For reference, we will call this combination “ES-NM” hereafter. FIG. 3 describes this combination as per my prior teachings in this patent chain.

The combination of those ES-NM forces describes the inclination angles, the longitudinal angles, general distances, and chemical properties better than electrostatic alone. Alone, that is useful and my prior filing.

Yet, the nucleomagnetics force applies in that same alignment between particles; it has no forces in other directions. The force only moves the particles in a line (1D) between the particles. My prior invention results are better that electrostatic or quantum-statistical calculations, but not perfectly predicting all observations.

The present invention goes a step further to provide its preferred embodiment of the next force calculation that a separately-calculated, different force in 3D called an ES-NM particle-tensor. FIG. 4 shows the equation for the method of calculation of the ES-NM tensor based upon segmenting the particle into at least six segments, calculating the basic ES-NS for those, and using rules below to combine them to determine the applicable force in 3D.

Further, there are external forces, such as external magnets, other molecules, gravity and such, which would provide more refined calculations as the subatomic particle level. Plus, there are potential energy objects including momentum and nucleomagnetics orientation. FIG. 5 shows that Total Energy formula of the present invention.

Within the settling position ‘well’ of electrons in an atomic structure, the present invention calculates velocity and momentum of each particle. Importantly, its movement oscillating about the settling position and position at each point in the present invention process is tiny, but measurable by the present invention method. Specifically, compared to prior art, this system calculates combinations of force (by positions) and momentum (from velocity) below Heisenberg current theoretical limit. FIG. 6 depicts the output of the present invention for an example of particle tiny oscillations with velocity and momentum.

It is important to note for each of the claims, that the particle position is set at 10⁻¹¹ meters, which is the typical range. However, we have a radius of the particle used in FIG. 11 and others which is 10⁻¹⁴ meters. The six-segment methodology described later, then provide accuracy only with the size of the particle which is 10-14 meters. FIG. 6 displays that calculation to a precision of 5 for an example where the particle lies directly on the nucleomagnetics axis (x=0, and y=0) while allows slightly better accuracy, however, for the Claims herein, the accuracy claim is only within the 1-particle distance in any direction in 3D space. Since we segment a particle as part of the process, the results only get accuracy with the distance of that segmentation. One cannot expect accuracy with 1/100 of particle radius (10⁻¹⁶ m), if using an estimating method that uses the entire radius in each direction to calculate an estimate of the real-life value. The core of the present invention is the applying of this calculation method of segmentation to my prior filing anisotropic force, in combination with other known force, to improve the evaluation, and animation of subatomic particles within chemical reactions.

FIG. 7 depicts geometrically how to determine the two different particles, and angles used for the two different f(θ) from the FIG. 2 formula. One inclination angle (703) from one nucleus particle's nucleomagnetics inclination axis (701) in the example is from the nucleus (702) relative to the line (704) towards the other particle, remains different from the other particle's (706) nucleomagnetics axis (707) which generates its own separate inclination angle (705) relative to the line (704) to the first particle (the nucleus) (702). Also, the calculation of the force uses the distance along the direct line (704) between the two particles.

This system is further emphasized because of the present teachings in AVSC that electrons take consistent inclinations in subshells. That means the three electrons in each hemisphere in subshell-4t and three in the other hemisphere will likely have similar inclinations and distances to electrons to in subshell-3m. The AVSC subshell 3D structure thereby reinforces harmonics. Six rotational interactions at one frequency help drive other electrons, and only certain combination are reinforcing.

FIG. 8 depicts that in Periodic Tables, these particles tend to settle into the same inclination angle. A nucleus (809) and its nucleomagnetics axis (810) have multiple particles (801, 806) at the same angle (804) looking from the equator in this view. Each of those have nucleomagnetics force which is 1× (803) in one direction and up to 2× (802) at its equator. Further, those particles can be at slightly different positions, different orientations, and different rotations (807).

As a six segment, the present invention provides methods to calculate for each particle the axis orientation, rotational speed, and forces accelerating or changing in a different orientation each particle.

In the preferred embodiment of the present invention, it is a system that includes these methods for calculating the prior art forces and my prior and present invention forces, calculating every particle nucleomagnetics axis, to create a computer system which has each particle depicted in subatomic 3D space, over time, with:
Position of the particle
Velocity of the particle
Acceleration as the expressed portions of the above forces summed as particle-particle interactions with other surrounding particles
Nucleomagnetics Axis orientation of the particle
Nucleomagnetics Axis rotation in 3D of the particle
Acceleration of axis rotation as the expressed portions of the above forces as particle-particle interactions with other surrounding particles on the particle's internal structure segments (versus on the particle as a whole)

Calculating Particle Tensor by Present Invention Six-Segment Method Applied to Subatomic Particles with the AVSC Nucleomagnetics Method

The basic process of the present invention segments a particle into at least six sections and calculates the knowable forces upon that as if separate. However, different elements of the segment forces create different impact for the particle as a whole. Some move the whole particle, and some cause the particle to rotate.

In the preferred embodiment of the present invention, the six divisions are orthogonal, meaning in the orthogonal (x,y,z) coordinate system chose for the computation to come to an equal and balanced structure when combined. It is six because from the subatomic particle center the segments are opposing. That is, for ‘x’ one is positions in the +r distance in direction in ‘x’, and the other is on the ‘opposite’ side of that center, the −r distance in direction in ‘x’. These offset positioning occur int eh present invention not matter how many segments are chosen, although the preferred embodiment is two (2) opposing positions in the three (3) orthogonal directions. That is, 1/6 would be in the x direction moved a distance:
the particle location plus the radius of the segment of particle in the chosen ‘x’ direction. Note that that particle segment is not a sphere, so that radius calculation is a mathematical center of that slice of a sphere. A knowledge person can calculate those, and can choose a reasonable estimate as determined by the balancing of calculations versus accuracy requirements.

It is understood that a knowledgeable person may calculate the ‘r’ using the integral of the distribution of the segment of the particle. That radius will not be the traditional ‘r’, but ˜0.7r which might get applied as the ‘segment center-of-force’ position which then calculates relative to the whole particle position as the ‘segment center-of-force radial distance’ as used below. It is our intention that both me knowable distances, and either can get applied depending on the user application.

In the present invention method, it calculates the force at the distance, based upon the particle radius, plus and minus in each 3D direction. That is 1/6 at:
Particle Location plus ‘segment center-of-force radial distance’ in x-direction
Particle Location minus ‘segment center-of-force radial distance’ in x-direction
Particle Location plus ‘segment center-of-force radial distance’ in y-direction
Particle Location minus ‘segment center-of-force radial distance’ in y-direction
Particle Location plus ‘segment center-of-force radial distance’ in z-direction
Particle Location minus ‘segment center-of-force radial distance’ in z-direction

FIG. 9 depicts a side view of these force, focusing on two of these dimensions (since paper is 2D). FIG. 10 depicts, in 3D, these six locations in the orthogonal (x,y,z) coordinate system for the calculation method of the preferred embodiment of the present invention. This shows that each with the 1/2 on each side of the centers include all three dimensions in their results, so we have six results (2 sides×3 dimensions), and hence 1/6 in the preferred embodiments.

The present invention method for calculating the additional ES-NM segment-tensor uses the following rules:
The two (2) 1/6 segments that are ‘moved’ in that same dimension are math added (‘netted’ if direction opposite) as they move the whole particle
The remaining four (4) force calculation in the chosen analysis dimension for particles ‘moved’ in other orthogonal dimensions for each segment are compared, and the minimum is utilized as an additional force for acceleration of the whole particle
For whole particle movement, the elements above the minimum are not expressed (utilized)

FIGS. 11, 12, and 13 depicts the forces getting compared for a minimum from other dimensions, and forces combined from the target dimension. Force calculations in the segment that have the ‘moved’ in the same dimension as analyzing get added (1106). Force calculations in the four (4) positions (1103, 1106, 1107, 1108) ‘moved’ in direction not in the direct analysis dimension, get compared for the minimum, which becomes the whole particle movement (1109).

The present invention intends by is use of ‘at least six segments’ to include calculations that use more computational work to utilized smaller segments, and thereby different segment radial distances. A knowledgeable person can determine if the extra computational effort yields more accurate results in excess to the computer computational cost. The 6-segment is the preferred embodiment because of its low minimal processing that still yields differentials (2×) in three (3) dimensions; hence, the six (6).

FIGS. 21 and 22 depicts the calculation of the whole particle force using the present invention 6-segment method. FIG. 21 focuses on the calculation fo the net force (E-S+N-M) for each segment. FIG. 22 then shows that for the on-dimension segments, the forces fully applies. Yet, for the off-dimension segments, only the minimum of those apply. Further, it is the teaching of the present invention that minimum is applied to zero such that if one segments gives a positive force and any other segment provides a negative force, then the ‘minimum’ for the purpose of this calculation is zero, not the mathematical negative number. As a result, that on-dimension force, unchanged, plus the minimums of the off-dimension becomes the whole particle force with the extra surface differential E-S+N-M force.

It is important to note that the direction of that force is slightly different than a whole particle calculation although the bulk of the force is along the particle-particle 3D direction (line). The present invention could apply a different ordering of the math; it could subtract out the whole particle to show on the surface differential. That would show the surface differential separately from the whole particle ES-NM calculation. A knowledgeable person may apply those other sequences, and those presentations separately are other embodiments of the present invention.

Method to Calculate Particle Nucleomagnetics Axis Rotation

While the minimum of the segment-tensor moves the whole particle, the excess force is not ignored. Instead, that force creates a rotation of the particle. That is important because it moves the nucleomagnetics axis, which in turn, changes the ES-NM force calculations with other surrounding particles. That makes the present invention require a computer.

The present invention method for calculating the rotational force uses the following rules:
The form in the direction for particle segment ‘moved’ in that same dimension are already fully applied to whole particle movement, so they are not part of the rotation calculation method in the preferred embodiment of the present invention.
For the other segments, ‘moved’ in other dimensions, the force, in excess of force moving the entire particle ‘minimum’, in each orthogonal dimension for each segment is compared, and the rotational force of opposite segments (the ‘plus’ and the ‘minus’ pairs in each orthogonal direction). The net of those forces is utilized as an additional force for acceleration for the acceleration of particle rotation for each dimension. The combination becomes a 3D direction for that force applied to the segments of particles at the segment radial distance.
For whole particle, all the elements of force get used in one expression (whole particle movement) or the other (particle rotation).

It should get noted that these are force, which generate acceleration. The calculation changes the rotation, which changes the positions. A knowledgeable person can apply this three-level standard of physics and mathematics.

FIG. 11 depicts that geometric elements of the whole particle with same dimension segment forces getting added, and for off dimensions segment forces getting compared with the minimum moving the whole particles. FIG. 12 and FIG. 13 depicts that geometric elements for the excess force in one dimension to another dimension (say x, to z) getting compared with the minimum creating rotational force on the particle, and not whole particle movement. FIG. 12 is when two are in the same direction, and the difference is the net rotational force. FIG. 13 is when two are in the opposite directions to the target dimension, and the net is the net rotational force.

FIG. 23 depicts the calculation of the torque components based upon eliminating the whole particle elements using the calculation method of the present invention.

Incorporation of Other Forces and Results

This calculation of nucleomagnetics at the particle level also leads to calculation of traditional magnetics by the engineering right hand rule. Now that particles move, they create traditional (macro-) magnetic forces. The present invention intends to add these additional forces to the processing methods. Further, the preferred embodiments will include external magnetics and gravity and other forces which impact subatomic particles.

One embodiment determines that passing of particles through a slit, with the nucleomagnetics rotation causing change in the movement direction. Only rotations in line with the slit, as in FIG. 14, succeed, which other nucleomagnetics orientations (FIG. 15) and rotations (FIG. 16), drive particles into the sides of the slit. The results are particle polarization, but determined giving particles this additional geometric attribute of axis, rotation, and change of rotation

It is the teachings that these rotations rates and orientations for subatomic particles interact at the speed of light for nucleomagnetics force. As such, distance and frequency are mathematically linked.

Specific to the mathematics, harmonics is generally a multiplication for a third interaction. That is, if particle A and Particle B achieve a stable interaction at 10 rotations per second, and particle A and Particle C achieve a stable interaction at 13 rotations per second, then the combination achieves synchronization, and measurability externally, at 130 rotations per second, the multiplication of those two. Only the multiplication level has the maximum and minimum strength of all three in harmony. Other rates have the rotation generate energy (field strength in a wide range of directions) which are not readily measurable because some particle is 2× and another on is 1× something.

An example of using the present invention for traditional magnetics occurs as the particle segments rotate. FIGS. 15, 16, and 17 presents three situations where a particle moves through a slit with solid layers of other particles on each side. FIG. 15 depicts the situation that the particle rotates which changes the strength of nucleomagnetics moving the particle off the straight path through and into one wall. FIG. 16 depicts the situation where the particle rotates on its equator and passes through the slit successfully.

In the preferred embodiments of the present invention, one particle creates movement and rotation forces on the particles, and thereby other atoms and molecules. If one rotates, the second would like to rotate at the same rate. That would work perfectly if everything were just two particle systems. As the particle rotate, the f(theta) factor of one changes in synchronization to the f(theta) factor of the other creating a normalized net force, but only if they are in synch.

Finally, using a six-segment method, the present invention provides methods to calculate the rotation harmonics between particles. Effectively, within the settling position ‘well’ of electrons in an atomic structure, its positions and momentum create an ellipse (or may better stated given the nucleus energy well, it operates like a pendulum). Its movement is oscillating about the settling position. The total energy of that present invention process is tiny.

FIG. 18 depicts an electron particle moving within an cllipse around is settling position. However, that movement will also have particle rotational movement which creates a changing nucleomagnetics field. This embodiment of the present invention calculates the base state for spectrum analysis for various molecules at various temperatures and states.

FIG. 19 depicts the 1D prior art associated with this calculation for comparison. It has no 3D elements.

The present invention provides a method to calculate the rotation that works in harmonics for multiple particle interactions, especially in state changes. That is, electrons change states at specific rotational and ellipse combinations based upon the computer calculations; those are move complex than can fit on one page. Specifically, each particle has a settling position, and from there, the particles are in different 3D space energy wells at different distances. In that way, if one rotates and travels an ellipse, and a second rotates and travels an ellipse, the third interaction only works, or settles into, a new combination calculated by one embodiment of the present invention.

The number of these combination, especially the exterior combination, outer subshells, demonstrates the number of line in electromagnetic spectrum in the present invention AVSC teachings. A hydrogen has, as its strongest, a simple red line spectrum (656 nm). The spectrum of end cap AVSC configuration, up to 26-Fe Iron, have multiple combination, and thereby more lines. Simply moving to 27-Co Cobalt, creates an equatorial electron which masks multiple combination that were exterior in 26-Fe Iron. As such, the number of lines in the spectrum reduces dramatically. The present invention provides that engineering calculation method.

An external particle, such as a photon, with a rotation, can increase the movement of at least one electron in an atomic system. If that continues in multiple cycles, that extra movement may push that electron out of a chemical bond position as above defined.

This analysis will also identify frequencies that drive electron movement beyond the 3D well which triggers chemical reactions. All of those are part of the claims herein.

The methods of calculated nucleomagnetics above often gets added to the methods of calculated traditional magnetics to create a combination to describe a subatomic particle's positions, orientation, rotation, and change in rotation. FIG. 20 depicts one example of this embodiment where the method without gets combined with external magnet forces to create the combination.

System to Present Electrostatic, Nucleomagnetics, and Derivative Forces in 3D Over Time

As a result, the combination of the present invention methods creates a system that the position, velocity (momentum), and acceleration of all whole particles in a chemical reaction in three dimensions (3D) in a table. Further, the present invention system has, for each particle, its nucleomagnetics axis and field orientation, its rotation, and the acceleration of its rotation in three dimensions (3D) in a table. As a result, the system will produce a time-study with that database with every particle and those attributes in another table.

The calculation of traditional magnetics by the change from the prior time period (a calculated force increasing-north at the point just left and correspondingly decreasing-south at the point arrived) is the traditional magnetic calculation in a further embodiment of the present invention.

In addition, the nucleomagnetics axis rotation changes based upon external magnetics which provide a torque rotational change acceleration at a 3D angle to the current orientation and rotation. While torque is a known method, its application to particle axis is one embodiment of the present invention.

System to Present Nucleomagnetics and Derivative Forces in 3D Over Time as Animation

Many existing systems can take the present invention time-study with all those attributes with specifications in three dimensions and creates animations. Those methods are well known and incorporated into the present invention system. The system is unique because prior use did not animate subatomic particles, the particular use of the present invention.

FIG. 20 depicts the computerized processes and tables which comprise this system. The data tables have particle level nucleomagnetics, rotation of such, and rotational acceleration or torque by the present invention methods. The process moves from initial state and processing parameter input, to calculating the force, to organizing in another table, the separate particle-particle force, which are then combined to get total forces on specific whole particles, which leads to various time-study reports, animation outputs, and reports from that sequence of data, including, as requested, oscillation frequencies.

Describing the Claims

As a result, the Claims follow the teaching, methods, and system detailed above.

Claim 1 is divided into four logical blocks including: a) the specialized calculation of subatomic particle anisotropic force with an axis orientation; b) the use of computers as the number of calculations requires that mechanical power; c) the output options, with its enhanced accuracy standard, for the whole particle, and particle axis, and particle calculation relative to two atoms from its positions (bonding), or changes to such bonding, and d) the segment procedure. While a) relates to the FIG. 2 formula, d) is a further mechanical procedure using a computer (b) to get usable results (c);

The subatomic particle anisotropic force has multiple specializing characteristics. First, because it is anisotropic, that immediately excludes electrostatic charge isotropic force calculations (prior art methods). The Claims include the wording ‘including’ as any use of the specialized anisotropic force FIG. 2 is clearly understood as combined with the prior art FIG. 1 to creates the combination as in FIG. 3.

For a molecule of cholesterol (C₂₇H₄₆O), for one embodiment use in pharmaceutical industry, with 93 atoms, the calculations are 74 factorial (74!), which is more than 1 billion atom-to-atom interactions. Yet, the present invention system calculates each particle which is seven (7) particles, one nucleus and six electrons, for each 06-C Carbon atom and so on which makes this 500 factorial (500!). As such, the mechanics of a computer is necessary for commercial use of the present invention. The computer is especially needed with the (d) six-segment further number of calculations. In one embodiment of the present invention, a knowledgeable person will apply common sense that at 1/distance-cubed, for atoms on the other end (23× away), certain calculations will be optimized (ie, eliminated) for immaterial results of that 500 factorial potential. At 1/23 cubed, the accuracy is 1/12,167, so if 0.0001 accuracy is not required, then a substantial number of permutation get excluded from the computer calculation process.

In block (c), three outputs are required. This is mostly because the position and movement outputs have common understanding. The orientation, rotation and its change are described [0008], starting at [0020] and truly only follow from the teaching that subatomic particles have such specialized isotropic force axis. The bond and bond-breaking logic flows requires incorporating my prior filings rather than repeating all that complexity again; one electron becomes the linking of two atoms by holding net attraction to both; usually this is because of 3D open paths to the nucleus for attractions with the surrounding electron repulsions as both a) less and b) stabilizing the settling position (bonding angle). Claim 1 covers a computerization method with a particle level magnetic-like filed, nucleomagnetics, which generates certain force calculation in combination with a particle segment method as described beginning at [0029] and FIG. 11. It combines three logical blocks. The computerization, (b) above, as described at [0068] and elsewhere, includes the combination of data and processes in FIG. 20, which store and process for the present invention methods, the force which determine acceleration, and thereby position changes. It is important to note that this is specific particle location and specific particle velocity, axis orientation, rotation, or its position as the dual attraction of a chemical bond, and changes (breaking) such bonding positions. The method of calculation is described in FIGS. 2, 3, and 5 and at [0015]. Its accuracy is discussed at [0024]. First, the method specifies the combination of data for a chosen particle is position, velocity, rotation, and associations with other atoms, and such changes of associations. The electron particle as ‘associating particles of two atoms into bonds’ aspect began with the teachings of my U.S. Ser. No. 15/256,865 and other filings incorporated by reference. Second, the ability for such a method to determine all those follows the teachings that specified subatomic particles, for the calculation method, have a nucleomagnetics axis and force, different by the longitude, not the latitude, relative to that axis, its gross value beginning as the product of the particles involved, and decreasing at 1/distance-cubed as in FIG. 2.

The fourth logical unit (d) of claim 1 covers the segment method to estimate using a computer, an additional tensor forces that create rotation of the chosen particle itself as described in FIGS. 11, 12, and 14, and beginning at [0030]. The segment evaluation aspect of the claim is a key feature. Those expand upon my prior filings and claims which describe (a) the specialized calculation method requiring the additional mechanics of the computer. There is no 1/6

of a particle in nature. The rotation of the particle's axis is a key feature. The over a time study aspect is also a key feature. Those expand upon my prior filings and claims.

Claim 2 includes claim 1 with the addition that the 3-dimensional outputs of this calculation methods get further translated into a 2D screen animation of the computer. The present invention takes that calculation and applies it over time to get a time-study as in the examples in FIG. 15-17 at [0062] which can then become an animation on a 2D by known procedures.

claim 3 is dependent to claim 2. It adds the output of electromagnetic output which the distance and combination of rotations of two particles calculates their product as the harmonic. The special process is that a rotation of a particle gets transformed by the computer into a specific color.

Claim 4 is dependent claim 1. The difference is the fourth logical unit (d) substitutes the combination with external forces.

Claim 5 is independent, yet similar to claim 1. The difference is the fourth logical unit (d) substitutes as the segment method to determine additional tensor forces that create movement of the whole particle itself as described in FIGS. 11, 12, and 14, and beginning at [0030]. One of the key features of certain embodiments of the present invention is that this claim 3 calculation method creates a force not in the particle-particle line. It creates the 3D path that is not linear when combined with the particle-particle line forces so calculated (FIG. 3).

Claim 6 includes claim 5 with the addition that the 3-dimensional outputs of this calculation methods get further translated into a 2D screen animation of the computer. The present invention takes that calculation and applies it over time to get a time-study as in the examples in FIG. 15-17 at [0062] which can then become an animation on a 2D by known procedures. The difference is the fourth logical unit substitutes combines the segment method with external magnetic force to determine additional particle rotation forces described at [0030].

claim 7 is a system comprising a combination of at least two of these methods. Claim 6 is a dependent claim of claim 5 where the output is presentation method as animation as described at [0066]. Claim 7 is a dependent claim of claim 5 where the results indicate a change in chemical bonding over time. The teachings of chemical bonding as electrons holding net-attractive are part of my other filings, incorporated herein by reference, and the time-study aspect is described in the examples in FIG. 15-17 at [0062].

Claim 8 includes claim 7 with the addition that the 3-dimensional outputs of this calculation methods get further translated into a 2D screen animation of the computer. The present invention takes that calculation and applies it over time to get a time-study as in the examples in FIG. 15-17 at [0062] which can then become an animation on a 2D by known procedures.

Claim 9 includes claim 7 with the addition that any particle can change from net-attractive to one atom to net-attractive to two and vice-a-versa, and this system would report such calculation as an output.

### BRIEF DESCRIPTION OF THE DRAWINGS

FIG. 1 depicts Coulomb's Electrostatic Particle Force Formula

FIG. 2 depicts the Nucleomagnetics (Vigen) Force Formula

FIG. 3 depicts Net-Subatomic Particle Force (Vigen) Force Formula—ES+NM ‘Weak Force’

FIG. 4 depicts the present invention ES-NM Segment Differential Force (Tensor) on Particle by Vigen Segment Method

FIG. 5 depicts the Total Energy (Vigen) Force Formula of the present invention.

FIG. 6 depicts as 3D Time-Study of Forces for 01-H Hydrogen Particle-2 (e-1 m1) Alone

FIG. 7 depicts the various different particle inclination angles used in the present invention Force Calculations graphically; the angle, and thereby inclination angle factor f(θ) is different depending on the particle (A or B) and the direct line between the two chosen particles.

FIG. 8 depicts the particles of a 10-Ne Neon atom where three (3) electrons settle into the same alignment relative to the nucleomagnetics axis of the atom in each hemisphere.

FIG. 9 depicts a Comparison of using a whole particle versus a six-segmented particle where the position of the whole particle is at the center, yet the Calculation Using 1/6 as Point Located Plus and Minus in each of Three (3) Dimensions. This only shows four, two in each dimension

FIG. 10 depicts Calculating Using 1/6 as Point Located Plus and Minus in each of Three (3) Dimensions

FIG. 11 depicts Segment of Subatomic Particle Differential (Tensor) Force Calculation Method on Other Dimension Segments Comparison for a Minimum Consistent Force in the chosen dimension.

FIG. 12 depicts Particle Internal Rotational Force Calculation Method based upon the excess off-chosen-dimension force from four segments relative to the whole particle center where in the same direction netting to a rotation acceleration.

FIG. 13 depicts Particle Internal Rotational Force Calculation Method based upon the excess off-chosen-dimension force from four segments relative to the whole particle center where in the opposite direction, so offset to determine a rotation acceleration.

FIG. 14 depicts a Table of Rules to Apply 1/6 Force Split Calculation to either Combined or Rotational Elements.

FIG. 15 depicts Rotational Path of Particle through a Vertical Slit Rotating Horizontally by the changing sideways force driving the particle into one of the walls.

FIG. 16 depicts Rotational Path of Particle through a Vertical Slit Rotating Vertically by consistent sideways force allowing the particle to pass through the path in a generally straight line.

FIG. 17 depicts Rotational Path of Particle through a Vertical Slit Rotating Horizontally by the particle movement inducing a traditional magnetic field driving the particle into one of the walls.

FIG. 18 depicts the combination of subatomic particle movement in an ellipse around a settling position along with particle rotation itself with its nucleomagnetics strength shape (1× versus 2×).

FIG. 19 depicts the prior art calculation of electromagnetics harmonics as a single output (1D).

FIG. 20 depicts a comparison without and with an external force to the calculation of particle rotation.

FIG. 21 depicts an example calculation of the forces from the preferred embodiment of the present invention to generate six segments of a particle, and calculated the net force of Electrostatic (E-S) and nucleomagnetics (N-M) in 3D.

FIG. 22 depicts an example of the present invention method of calculation of the whole particle additional forces for each 3D dimension from segmentation method continuing the FIG. 21 example showing that same dimension forces move directly to the whole particle, and off-dimension forces apply on as the minimum of those four (4=2 other dimension×2 opposites).

FIG. 23 depicts an example of the present invention method of calculation of particle rotational force (torque) based upon the same data as FIG. 21 and FIG. 22, focusing on the elements that generate rotational force (torque) from differences in the excess force of opposing segments, then summed for each dimension.

FIG. 24 depicts the elements of the preferred embodiment computer processing and computer storage system with its specialized calculation methods and database tables.

### DETAILED DESCRIPTION OF THE DRAWINGS

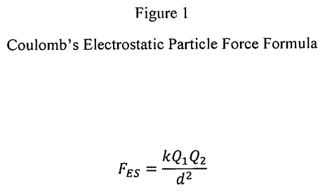

FIG. 1 is a Coulomb Equation for Particle Force. The force is a constant ‘k’ multiplied by the product of the charge of one particle or particle-set (Q1) with another particle or particle-set (Q2), with decreases at the rate of the square of the distance between the particles or particle sets.

### F=Force

k=Coulomb's constant
Q=The electrostatic charge of each particle
d=distance between the particles or particle-sets

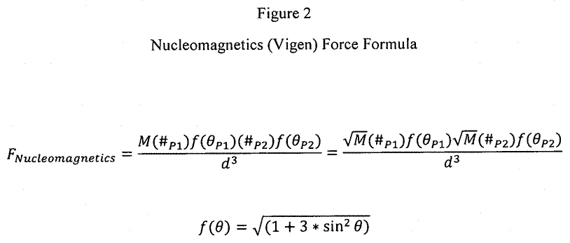

FIG. 2 is a Vigen Nucleomagnetics Equation for Particle Force. The force is a constant ‘M’ (or if applied to the particle separately \sqrt{M}) multiplied by the product of the number of nucleons (protons and neutrons, as arranged) of one particle or particle-set (P1) with another particle or particle-set (P2), with each of those adjusted by a factor based upon the inclination angle of the other particle relative to the first particle nueleomagnetics axis with the first particle as the vertex. The strength decreases at the rate of the cube of the distance between the particles or particle sets.

### F=Force

M or \sqrt{M}=Vigen nucleomagnetics constant (applied at M when to the product, or \sqrt{M} when to each particle-set)
#=The number of nucleomagnetics particles in the particle-set (for a nucleus this is the sum of the number of protons and neutrons, for an electrons, which do not combine, this is obviously always 1 (and not −1)
f(θ) is the anisotropic factor applies based upon the 3D nucleomagnetics axis to each particle (particle-set)
d=distance between the particles or particle-sets

Further, that factor runs between 1× and 2× based upon a calculation of the square root of the sum of one plus the product of three (3) and the square of the sin of that nucleomagnetics inclination angle. The separate formula shows the preferred embodiment of that force, at room temperature, which runs from 1× at the axis to 2× at the equator. That factor was separated specifically because for certain situations, a better form of that calculations exists.

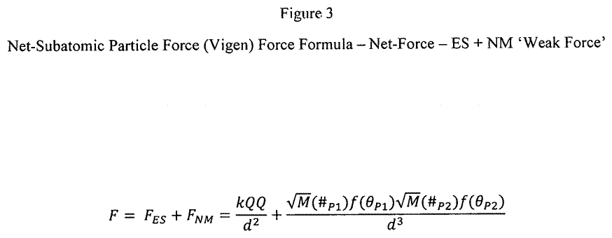

FIG. 3 is the combination of the electrostatic force calculation from FIG. 1 with the nucleomagnetics force factor from FIG. 2. This combination is an equilibrium for nucleus to electrons determining the settling positions relative to the nucleus and its nucleomagnetics axis.

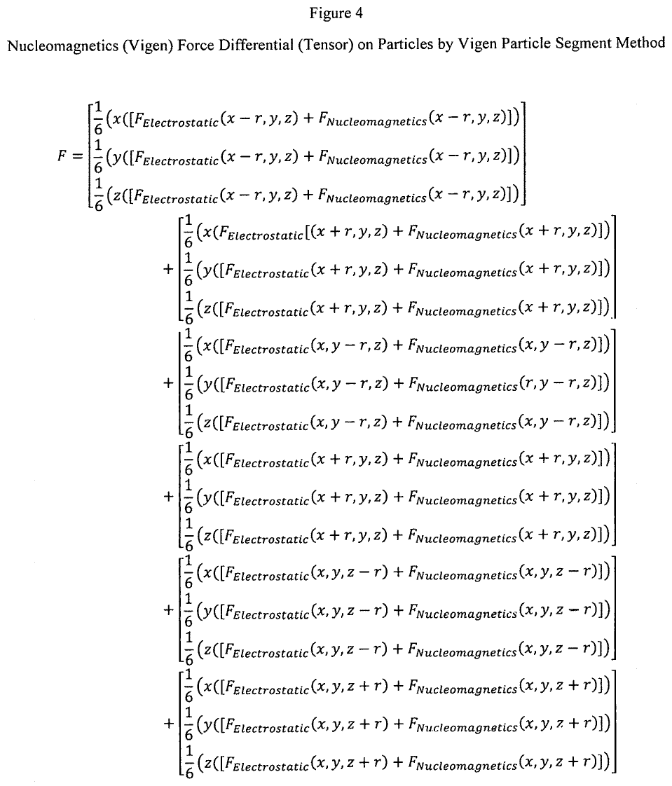

FIG. 4 is the mathematical method to calculate segments of a particle. In the preferred embodiment of the present

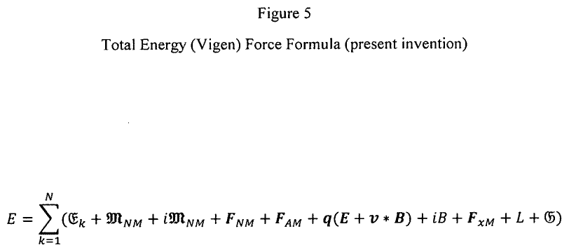

FIG. 5 details the breadth of energy driving any particle. This list includes more than the prior art which is limited to a) Electrostatic, b) Momentum from particle movement, c) external Magnetics. The energies related each particle not in the prior art include d) Nucleomagnetics of the particle, e) Net-Field Tensor,

The symbols describe:

[symbol]

Electrostatic force [symbol]
Nucleomagnetics force
F Net-Field Strength Tensor on particles or particle segments—differential energy on the particle away from the strongest portion of the surrounding field
q Charge of Particle Momentum force, as part of the movement within the settling position energy well
i Intermittently Expressed Gated Accumulator, the mathematics ‘imaginary number’
B Traditional external magnetic force
L Angular momentum, as a set of particles linked (as an atom, a molecule) rotates in the external frame of reference. This includes rotational momentum within a body [symbol]
Gravity (external)

### NM Nucleomagnetics

xM External traditional magnetic field
Rotational Rotational energy on segments of the particle relative to the center of the whole particle

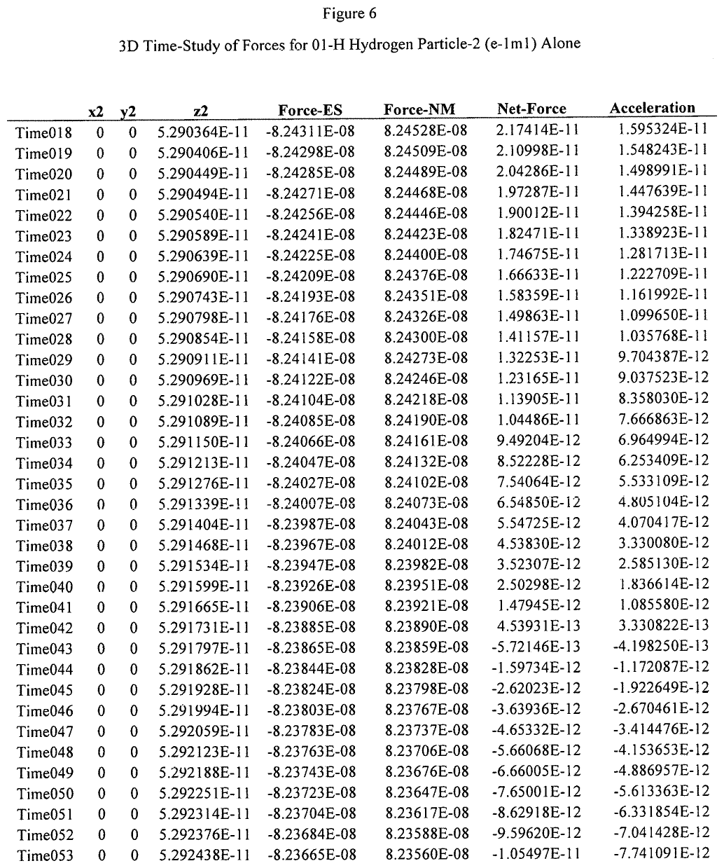

FIG. 6 depicts as 3D Time-Study of Forces for 01-H Hydrogen Particle-2 (e-1 m1) Alone. It shows that based upon the particle distances, the FIG. 3 forces get calculated, which then creates acceleration and velocity changes in a time-study. Because it uses discrete calculation, this embodiment of the present invention does not yield the exact calculation of a mathematical integral, which shall get used in other embodiments.

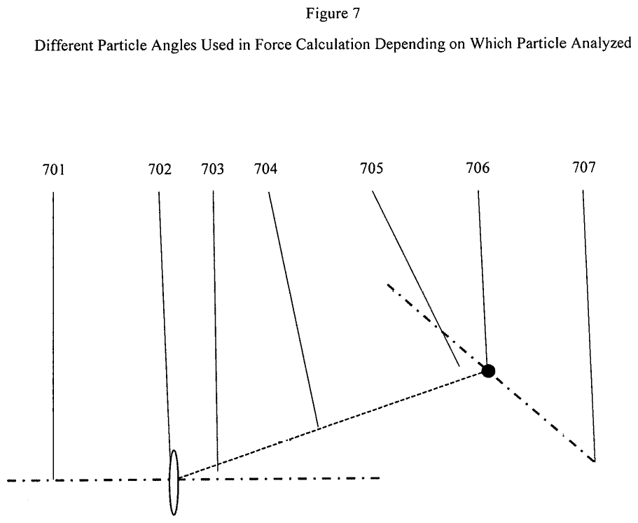

FIG. 7 depicts the various particle inclination angles used in the present invention Force Calculations graphically; the angle, and thereby inclination angle factor f(θ) is different depending on the particle (A or B). One inclination angle (703) from one nucleus particle's nucleomagnetics inclination axis (701) in the example is from the nucleus (702) relative to the line (704) towards the other particle, remains different from the other particle's (706) nucleomagnetics axis (707) which generates its own separate inclination angle (705) relative to the line (704) to the first particle (the nucleus) (702). Also, the calculation of the force uses the distance along the direct line (704) between the two particles.

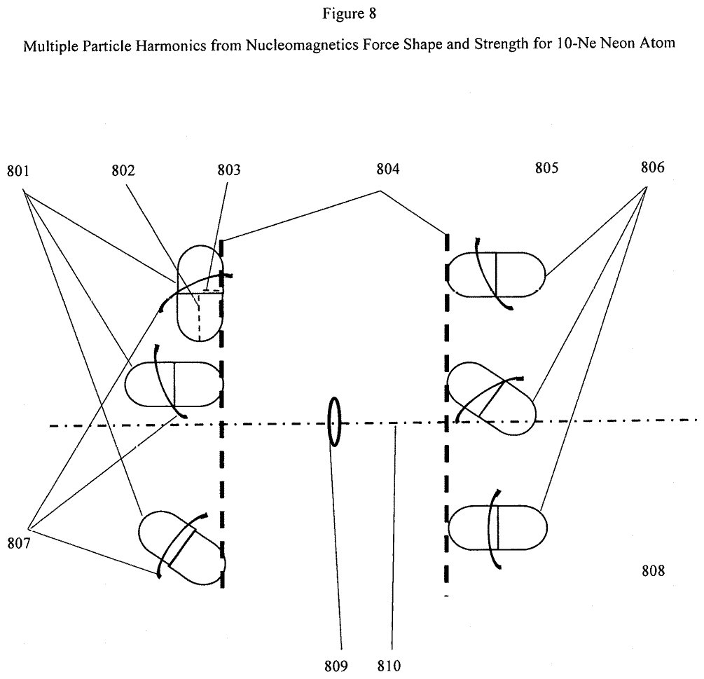

FIG. 8 depicts the particles of a 10-Ne Neon atom where three (3) electrons settle into the same alignment relative to the nucleomagnetics axis of the atom in each hemisphere. For an atom of 10-Ne Neon, it has a nucleus (809) and its nucleomagnetics axis (810). At the same inclination, distance along the axis (804), three electrons (3) settling in one hemisphere (801) and three (3) electron particles (806) settling in the other hemisphere. Each particle has a nucleomagnetics force which 1× as the poles (803), and 2× as the equator (802). As a result, rotation of the particle (807) creates changes in force, and it is further noted that those rotation (807) can be at different rotation rates and different orientations.

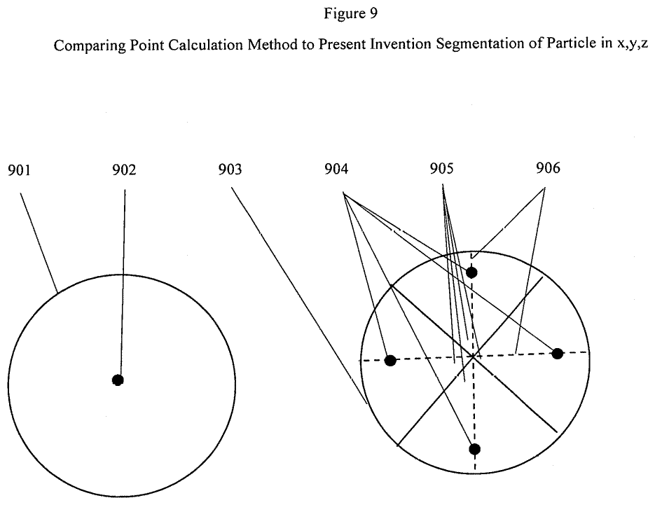

FIG. 9 depicts a comparison of using a whole particle versus a six-segmented particle where the position of the whole particle is at the center, yet the Calculation Using 1/6 as Point Located Plus and Minus in each of Three (3) Dimensions. This only shows four, two in each dimension. In the whole particle calculations, there is a center (902) and a particle edge (901) with is radius between them. In the present invention segment method, there are particle segments (905) of the whole particle (903), not at the center, located at a distance along the orthogonal x,y,z dimension directions (906) which create segments (904) with a center-of-force at the force center of that segment.

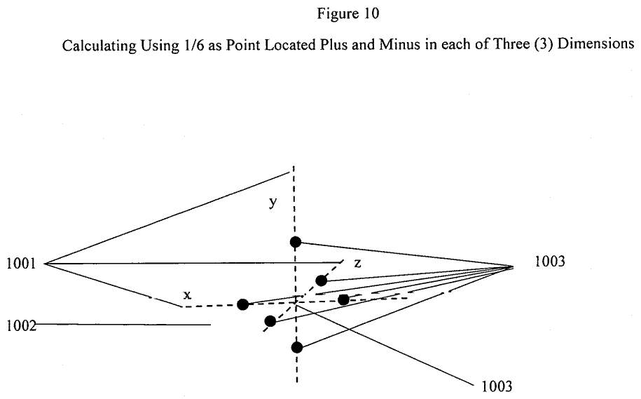

FIG. 10 depicts Calculating Using 1/6 as Point Located Plus and Minus in each of Three (3) Dimensions. Given the chosen orthogonal (x,y,z) coordinate system (1001), the present invention segment method calculates six segments (1003) of a particle, each 1/6 (1002) the energy of the whole, located at a radial distance on each side of the center (1004).

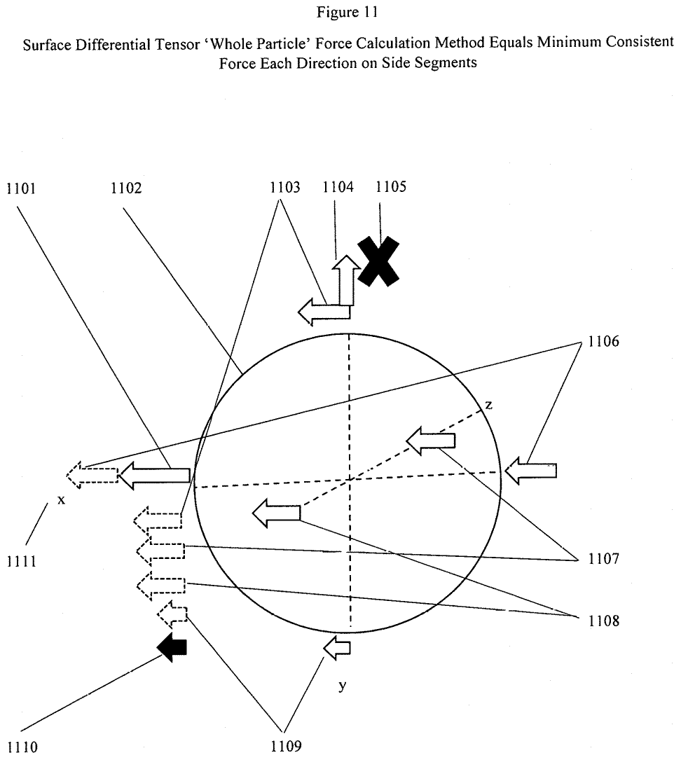

FIG. 11 depicts Segments of a subatomic particle Differential (Tensor) Force Calculation Method on Other Dimension Segments Comparison for a Minimum Consistent Force in the chosen dimension. The calculation is for one chosen dimension direction (x) (1111). The x force from one segment ‘moved’ in the ‘x’ direction (1101) are added to the segment moved in the opposite ‘x’ direction (1106) to create one component of whole particle force. The force direction in another direction (y) (1104) are not considered in this procedure (1105). However, the elements of the other four elements, two from each remaining ‘moved’ direction, (1103, 1107, 1108, 1109) are compared to create a minimum (1110).

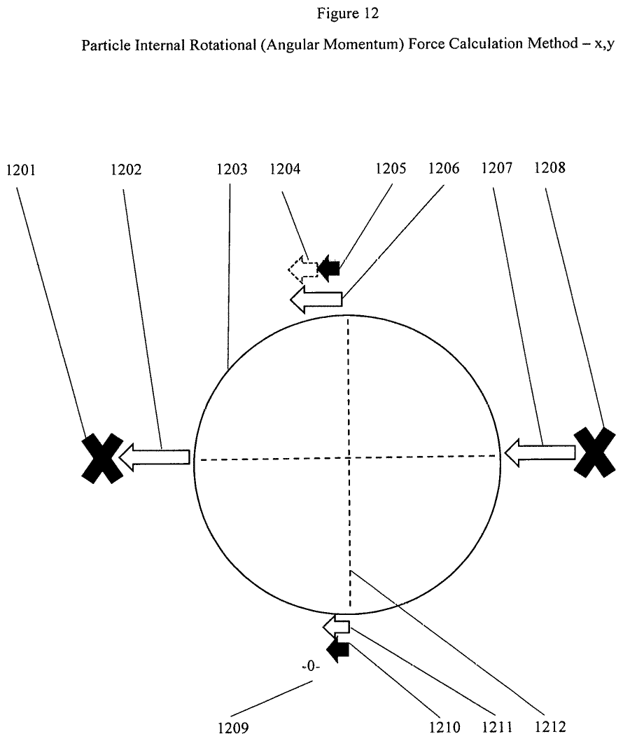

FIG. 12 depicts Particle Internal Rotational Force Calculation Method based upon the excess off-chosen-dimension force from four segments relative to the whole particle center where in the same direction netting to a rotation acceleration. The whole particle (1203) is analyzed based orthogonal x,y,z dimensions (1212). For the present invention rotation acceleration method, the forces (1202, 1207) from segments moved in that same direction are excluded (1201, 1208). The x force from one segment ‘moved’ in another direction (1206) are added to the segment moved in the opposite positioning in that same dimension direction (1211) and are compared to the minimum (1210) and the excess (1204) become the rotation acceleration and torque force from that dimensional combination. The rotational acceleration/torque on the other side is zero (1290).

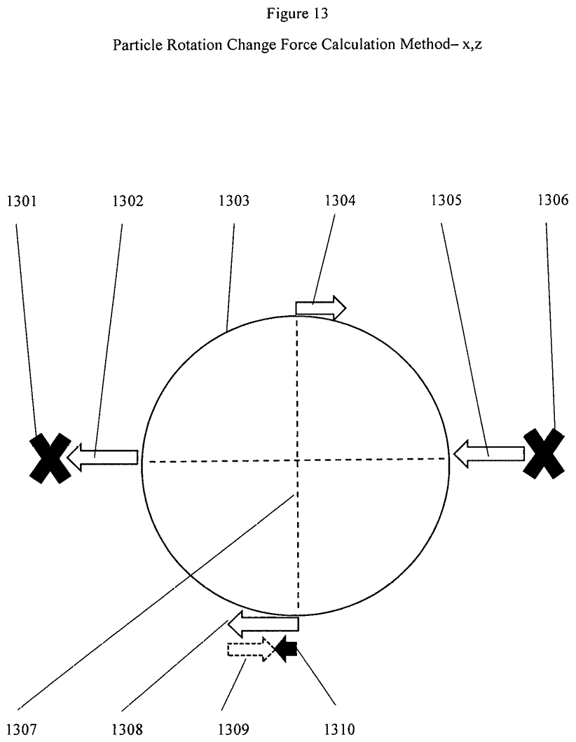

FIG. 13 depicts Particle Internal Rotational Force Calculation Method based upon the excess off-chosen-dimension force from four segments relative to the whole particle center where in the opposite direction, so offset to determine a rotation acceleration. For the present invention rotation acceleration method, the forces (1302, 1305) from segments moved in that same direction are excluded (1301, 1306). The x force from one segment ‘moved’ in another direction (1304) are added to the segment moved in the opposite positioning in that same dimension direction (1313) and are compared to the minimum (1310) and the net (1309) become the rotation acceleration force from that dimensional combination.

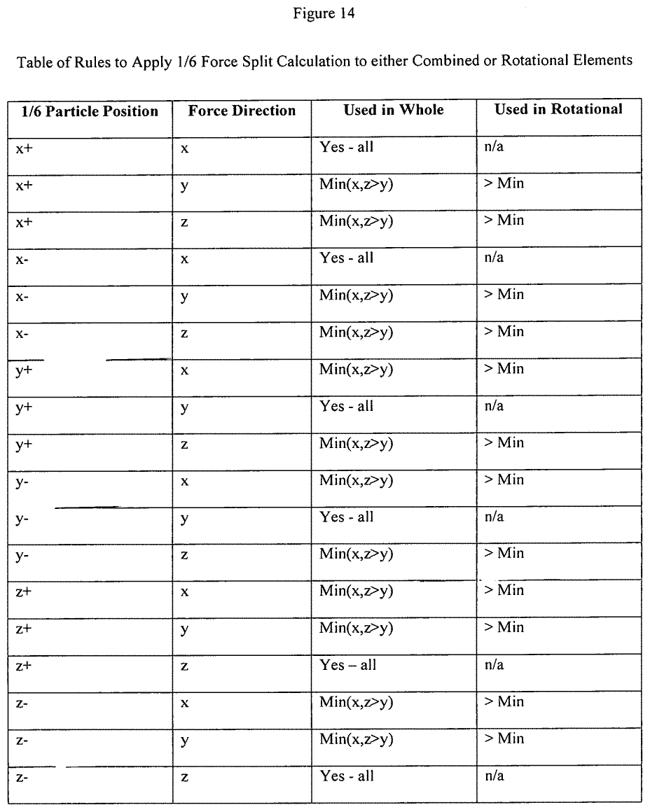

FIG. 14 depicts a Table of Rules to Apply 1/6 Force Split Calculation to either Combined or Rotational Elements. From two positions (+ and −) in three dimensions (Column 1), there are three orthogonal (x,y,z) direction of analysis (column 2), which yields two types of forces—Whole Particle Force (Column 3) and Particle Rotational Acceleration (Column 4). These are analysis for the six (6) positions in each analysis direction (3). The rules state that in the same positioning as analysis, all the force goes to the whole particle movement, and in unmatched combination, the minimum in that different direction goes to whole particle movement, and the excess goes to particle rotation acceleration/torque.

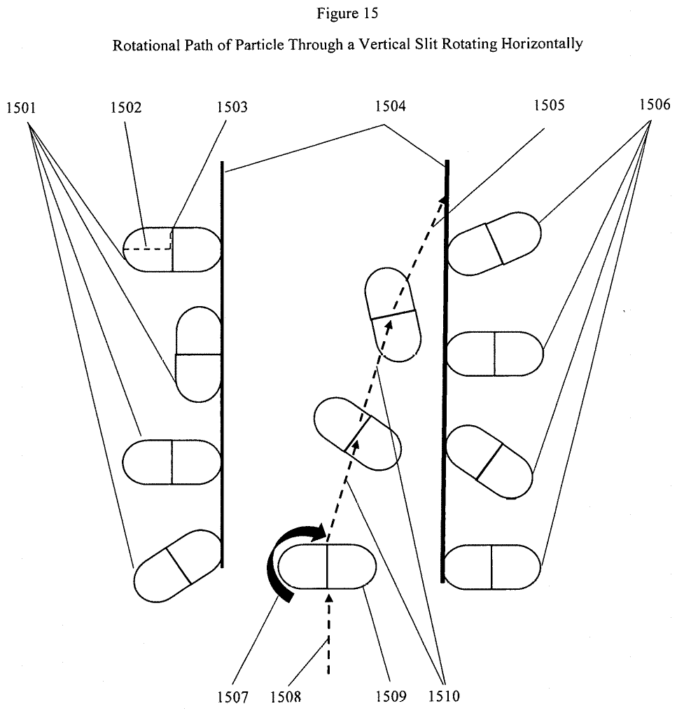

FIG. 15 depicts Rotational Path of Particle through a Vertical Slit Rotating Horizontally by the changing sideways force driving the particle into one of the walls. For a particle (1509) moving directly (1508) through a slit with walls (1504) of solid particles (1501, 1506) on each side (1504), and each particle having an axis force strength (1×) (1503), and equator force strength (2×) (1502). A rotation (1507), not aligned with the path of the moving particle (1508) creates a change in attraction/repulsion pulling the particle on a path (1510) that collides (1505) with one of the walls (1504).

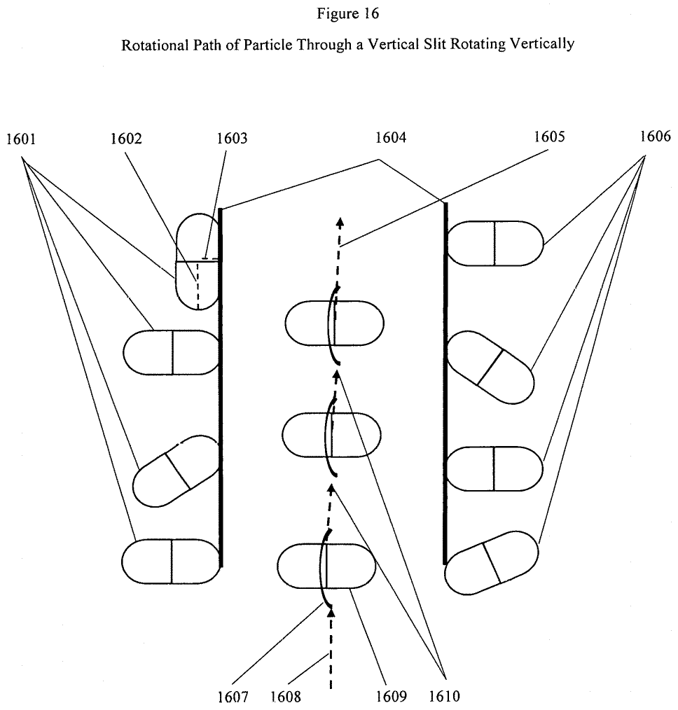

FIG. 16 depicts Rotational Path of Particle through a Vertical Slit Rotating Vertically by consistent sideways force allowing the particle to pass through the path in a generally straight line. For a particle (1609) moving directly (1608) through a slit with walls (1604) of solid particles (1601, 1606) on each side (1604), and each particle having an axis force strength (1×) (1603), and equator force strength (2×) (1602). Specific rotation (1607) of the moving particle (1609) aligned with the particle path (1608) creates an unchanging profile in attraction/repulsion pulling the particle on a path (1610) that does not collide with one of the walls (1604), but instead exits the slit (1605) in the same direction as its entrance (1608).

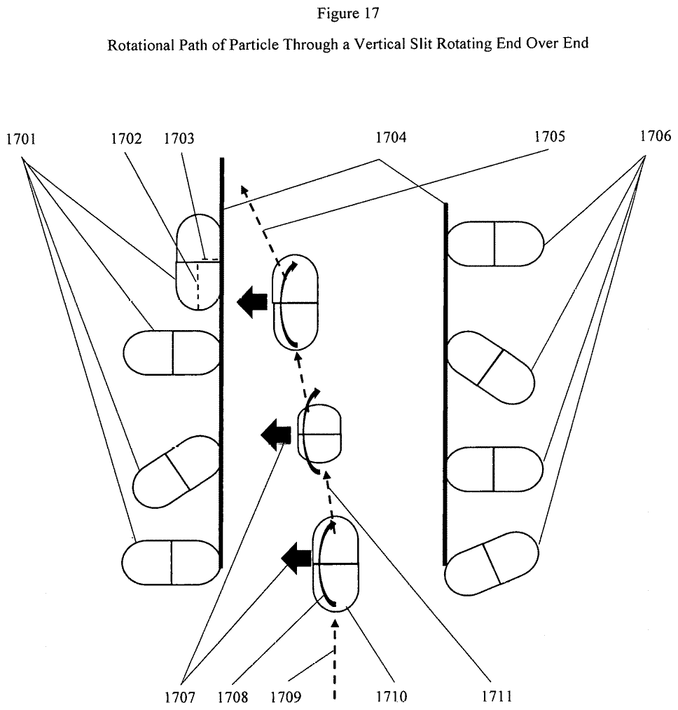

FIG. 17 depicts Rotational Path of Particle through a Vertical Slit Rotating Horizontally by the particle movement inducing a traditional magnetic field driving the particle into one of the walls. For a particle (1709) moving directly (1708) through a slit with walls (1704) of solid particles (1701, 1706) on each side (1704), and each particle having an axis force strength (1×) (1703), and equator force strength (2×) (1702). A rotation (1707), aligned with the path of the moving particle (1708), not with the strongest component towards the wall, creates a change in attraction/repulsion as a loop, and a traditional magnetics force (1707) pulling the particle on a path (1711) that collides (1705) with one of the walls (1704).

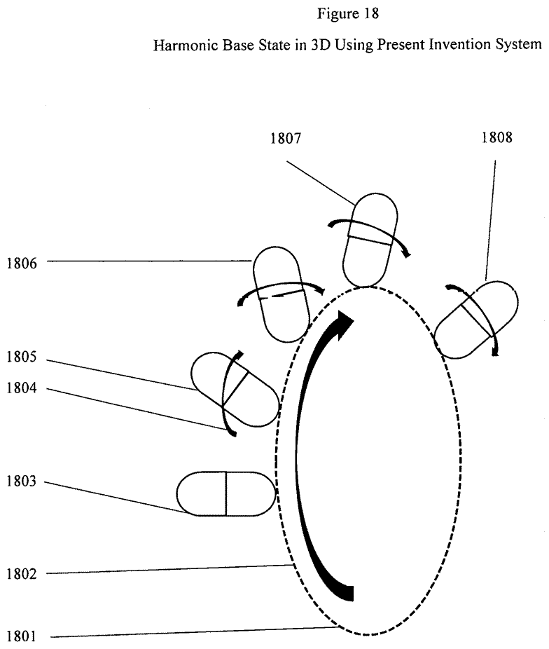

FIG. 18 depicts the combination of subatomic particle movement in an ellipse around a settling position along with particle rotation itself with its nucleomagnetics strength shape (1× versus 2×). Given a particle in the present invention method (1803), that rotates (1804) and moves (1805) in a time sequence (1806, 1807, 1808). That particle also moves (1802) around the settling position generally in an ellipse (1801).

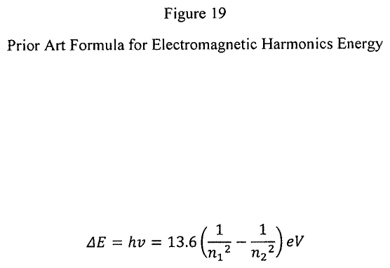

FIG. 19 depicts the prior art calculation of electromagnetics harmonics as a single output (1D). The change of energy comes as a single number determined the difference of 1/square-root of the energy level. That is multiplied by a constant.

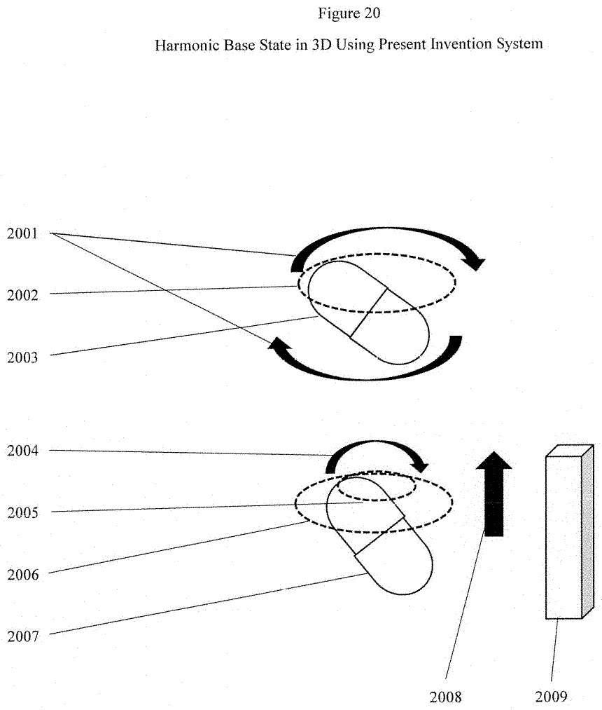

FIG. 20 depicts a comparison without and with an external force to the calculation of particle rotation. Without an external magnet object, a particle (2003) by the present invention methods will rotate (2001) in a certain pattern, typically, something like an ellipse (2002) in three-dimensional space. Without an external magnet object (2009) that creates a knowable force (2008) by a method introduced into the particle rotation calculations, the selected particle (2007) will rotate (2004) in different pattern (2005) in three-dimensional space than the path (2006) calculation without the external magnet.

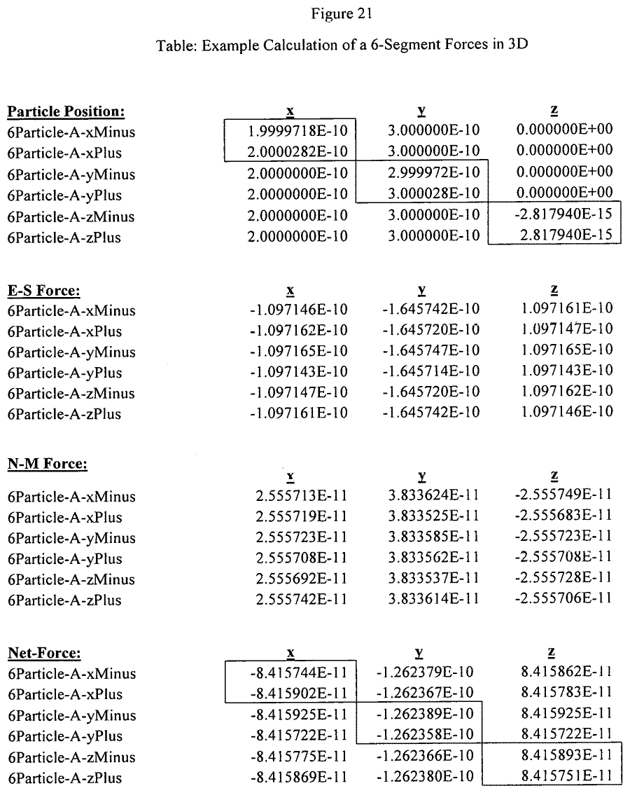

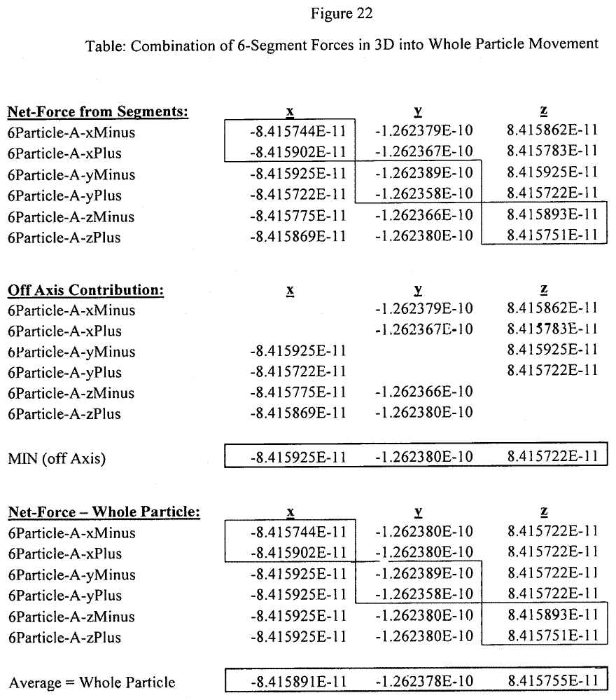

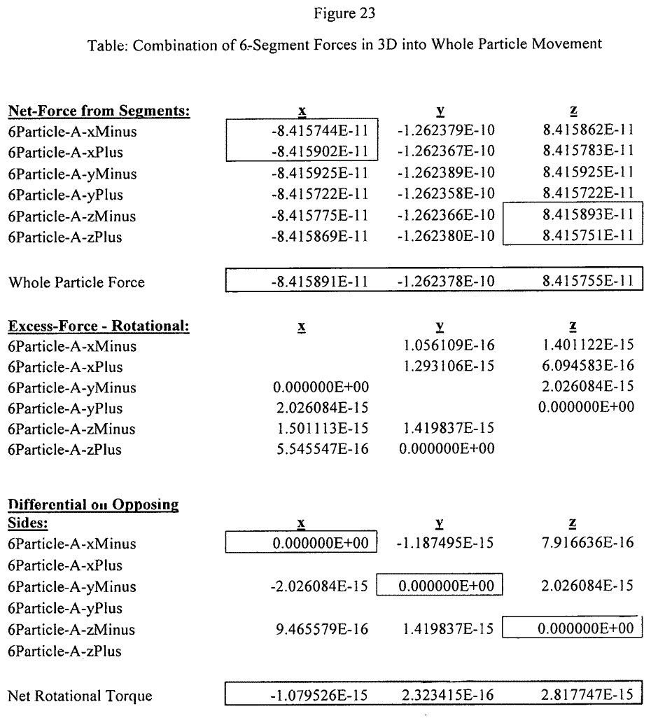

FIG. 21 depicts an example calculation of the forces from the preferred embodiment of the present invention to generate six segments of a particle, and calculated the net force of Electrostatic (E-S) and nucleomagnetics (N-M) in 3D. The first part details the positions of each segment of the particle relative to each other with the ‘z’ direction as the nucleomagnetics axis. To fit on a page, we used an example where the second particle is oriented with its axis towards the first so its f(θ₂)=1×. Note that the boxed cells shows the one dimensions that has moved the segment either one way or the opposite in that dimension; that is, in opposite pairs. Further, note that only one dimension is changed, and the other dimensions remains the same for each segment. The next sections calculate the E-S force, then the N-M force based upon that position. Finally, the E-S and N-M are combined for the basic net-force of the whole particle before the present invention methods to get applied on FIG. 22 and FIG. 23.

FIG. 22 depicts an example of the present invention method of calculation of the whole particle additional forces for each 3D dimension from segmentation method continuing the FIG. 21 example showing that same dimension forces move directly to the whole particle, and off-dimension forces apply on as the minimum of those four (4=2 other dimension×2 opposites). The first block shows the forces from 6-segment FIG. 21 example. The boxed on-dimension calculation carry directly to the final summation at the last section, which are also boxed. The second group indicates that only the off-dimension calculations are compared to generate a minimum of those shown at the bottom. Finally, those minimums are then averaged with the on-dimension force calculations to generate the final whole particle movement that includes the segment-method difference. Notice that the direction of the three in x,y,z is not exactly the same as the whole particle or segments separately.

FIG. 23 depicts an example of the present invention method of calculation of particle rotational force (torque) based upon the same data as FIG. 21 and FIG. 22, focusing on the elements that generate rotational force (torque) from differences in the excess force of opposing segments, then summed for each dimension. The first section shows the segment calculations from FIG. 21. The second section shows the different between each position and the Whole particle. Given the teachings that only offsets in the off-dimension apply rotational torque, the offset in same axis as analyzed boxes are empty (zero). In the third section, the opposing particle create opposing forces, so the different is calculated for each. That leaves only one net contribution for each pair of opposing segment to apply to the overall particle. Finally, the contribution from the net-pair of two off-dimensions becomes the final torque in that dimension. The final line is the rotational force (torque) on the whole particle.

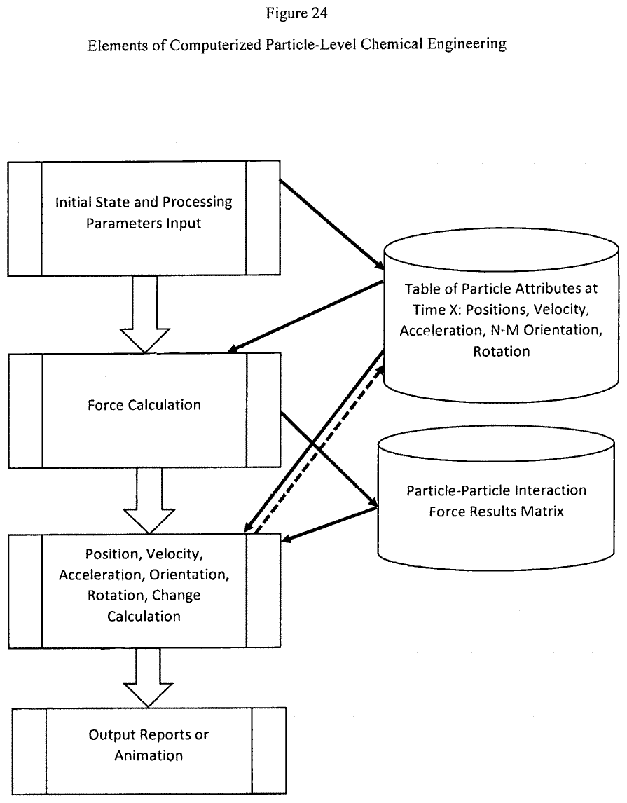

FIG. 24 depicts the elements of the preferred embodiment computer processing and computer storage system with its specialized calculation methods and database tables. Each table with its calculation expands to have an x-, a y-, and a z-, field and calculation to make the process fully three dimensional. From an input process for initial state and processing parameters, the system saves in a database table, the attributes on each particle (and in preferred embodiment that would include the segments of particles as well). That force calculation also processes into its calculation any impact of other forces (external magnetic, gravity, and others). From that information another step calculates the force for each combination, a large permutation, and stores those calculated forces in another database table of particle-particle interactions. That particle-particle data with particle data combines to calculate in 3D new position, velocity, acceleration from net force, nucleomagnetics axis and field, its orientation, rotation, and acceleration of that rotation (torque). Finally, the system provides outputs that can include animation in one embodiment of the present invention, and other reports such as total energy of the system, time-studies, changes on particles ‘bonding’ associations (see claim 9).

I claim:

1. a method
that includes calculating an anisotropic force for at least one subatomic particle, in an interaction or interactions with other subatomic particle or particles, where the calculation of such force is
the product of the number of particles in each side of the interaction times a constant determining the base strength of the force,
where such force decreases at one over the cube of the distance (1/d³) between the particles, and
where an axis fixed trough the center of the subatomic particle and its orientation, determines the relative strength of such force by a formula changing strength based upon its inclination angle relative to such particle axis, and not changing based upon its longitude angle relative to such particle axis,
with such inclination angle from that axis determining the factor of strength that has a change from the base strength as increasing from the poles, calculated as the base strength, to the equator, and
in both hemispheres, such forces have the same strength and direction at the same inclination from each base particle,
including both hemispheres being repulsive for interactions between nucleons and electrons,
to calculate, using a computer processing and database storage system, at least three of:
subatomic particle position within a subatomic range within accuracy variance of 10⁻¹⁴ meters in three-dimensional space,
subatomic particle movement within a subatomic range within accuracy variance of 10⁻¹⁴ meters per second in three-dimensional space,
subatomic particle axis, as described above, rotation within a subatomic range within accuracy variance of 10⁻¹⁴ meters per second of rotation in three-dimensional space,
atom associations into molecules via a common subatomic electron particle in such position that such particle is attractive to both atoms within a subatomic range within accuracy variance of 10⁻¹⁴ meters in three-dimensional space, or
changes in atom associations, including molecules, changing a particle position or orientation within a subatomic range within accuracy variance of 10⁻¹⁴ meters in three-dimensional space in the set, including but not limited to chemical reactions,
and
such calculation gets executed for at least six separate, opposing segments of the subatomic particle to calculate their relative strength, as if separate, in three dimensions, which creates a rotational force on the particle, as a whole, in three-dimensional space by mathematical comparison of the opposing segment and dimension calculations.

2. Claim 1 where the presentation of the three-dimensional results calculated by that method further processed for presentation on a two-dimensional screen as animation.

3. claim 1 where the rotation of any electron particle determines electromagnetic phenomenon, including but not limited to spectrum and waves, by changes in the anisotropic force profile changes in the chosen three-dimension frame of reference such that the rotation of particles, with their anisotropic forces gets converted by the computer into lights of a specific color.

4. Claim 1 where such calculation further uses external forces to the particles involved, including but not limited to external magnetics and external gravity.

5. a method
that includes calculating an anisotropic force for at least one subatomic particle, in an interaction or interactions with other subatomic particle or particles, where the calculation of such force is
the product of the number of particles in each side of the interaction times a constant determining the base strength of the force,
such force decreases at one over the cube of the distance (1/d³) between the particles, and
an axis fixed trough the center of the subatomic particle and its orientation, determines the relative strength of such force by a formula changing strength based upon its inclination angle relative to such particle axis, and not changing based upon its longitude angle relative to such particle axis,
with such inclination angle from that axis determining the factor of strength that has a change from the base strength as increasing from the poles, calculated as the base strength, to the equator, and
in both hemispheres, such forces have the same strength and direction at the same inclination,
including both hemispheres being repulsive for interactions between nucleons and electrons,
to calculate, using a computer processing and database storage system, at least two of:
subatomic particle position within a subatomic range within accuracy variance of 10⁻¹⁴ meters in three-dimensional space,
subatomic particle movement within a subatomic range within accuracy variance of 10⁻¹⁴ meters per second in three-dimensional space,
subatomic particle axis, as described above, rotation within a subatomic range within accuracy variance of 10⁻¹⁴ meters per second of rotation in three-dimensional space,
atom associations into molecules via a common subatomic electron particle in such position that such particle is attractive to both atoms within a subatomic range within accuracy variance of 10⁻¹⁴ meters in three-dimensional space, or
changes in atom associations, including molecules, changing a particle position or orientation within a subatomic range within accuracy variance of 10⁻¹⁴ meters in three-dimensional space in the set, including but not limited to chemical reactions,
and
such calculation gets executed for at least six separate, opposing segments of the subatomic particle to calculate their relative strength, as if separate, in three dimensions, which creates movement acceleration from the sum of the elements in separated in each chosen dimension, and the minimum of forces for segment calculated as off in non-chosen dimension.

7. a system, using a computer processing and database storage system, which includes mapping subatomic particles with their positioning, velocity, and net-force in three-dimensional space, from
a method
that includes an anisotropic force for at least one subatomic particle in the interaction or interactions with other particle or particles, where
the product of the number of particles in each side of the interaction times a constant determines the base strength of the force,
such force decreases at one over the cube of the distance (1/d³) between the particles, and
an axis fixed trough the center of the subatomic particle and its orientation, determines the relative strength of such force by a formula changing strength based upon its inclination angle relative to such particle axis, and not changing based upon its longitude angle relative to such particle axis,
with such inclination angle from that axis determining the factor of strength that has a change from the base strength as increasing from the poles, calculated as the base strength, to the equator, and
in both hemispheres, such forces have the same strength and direction at the same inclination,
including both hemispheres being repulsive for interactions between nucleons and electrons,
to calculate, using a computer processing and database storage system, at least two of:
subatomic particle position within a subatomic range within accuracy variance of 10⁻¹⁴ meters in three-dimensional space,
subatomic particle movement within a subatomic range within accuracy variance of 10⁻¹⁴ meters per second in three-dimensional space,
subatomic particle axis, as described above, rotation within a subatomic range within accuracy variance of 10⁻¹⁴ meters per second of rotation in three-dimensional space,
atom associations into molecules via a common subatomic electron particle in such position that such particle is attractive to both atoms within a subatomic range within accuracy variance of 10⁻¹⁴ meters in three-dimensional space, or
changes in atom associations, including molecules, changing a particle position or orientation within a subatomic range within accuracy variance of 10⁻¹⁴ meters in three-dimensional space in the set, including but not limited to chemical reactions,
and at least two of:
a method to determine such subatomic particle position, velocity, and the particle's axis orientation, and its associated changes in orientation in those forces over time;
or
such calculation gets used for at least six separate segments of the subatomic particle to calculate a rotational force on the particle, as a whole, within a subatomic range within accuracy variance of 10⁻¹⁴ meters in three-dimensional space;
or
where the rotation of any particle or particles as a set determines electromagnetic phenomenon, including but not limited to spectrum and waves, by changes in the anisotropic force profile changes in the chosen three-dimension frame of reference;
or
such calculation uses the combination of any particle's axis rotation and external magnet forces to determine a change in any particle's axis rotation

8. Claim 5 where the output is au animation with representation of subatomic particle positions and movements over time translated from the invention three-dimensional data table for screen presentation in two-dimensions.

9. Claim 5 where the output reports changes such that the net forces on any particle changing from attractive to only one atom to attractive to two atoms, or vice-a-versa.
